(19) United States
(12) Patent Application Publication
(10) Pub. No.: US 2025/0093144 A1
(43) Pub. Date: Mar. 20, 2025

(54) INDUCTIVE POSITION DETERMINATION SYSTEM WITH VARYING COIL GEOMETRY, AND CORRESPONDING POSITION DETERMINATION METHOD

(71) Applicant: Infineon Technologies AG, Neubiberg (DE)

(72) Inventors: Gernot BINDER, Klagenfurt (AT); Sebastian BERNER, München (DE)

(21) Appl. No.: 18/824,408

(22) Filed: Sep. 4, 2024

(30) Foreign Application Priority Data
Sep. 20, 2023 (DE) 102023209159.3

(51) Int. Cl. G01B 7/00; G01B 7/30

(52) U.S. Cl. CPC G01B 7/003; G01B 7/30

(57) ABSTRACT

The present relates to an inductive position determination system including a planar excitation coil and a first and a second planar receiving coil arrangement arranged within the planar excitation coil, and a target that is relative to the first and second planar receiving coil arrangements, wherein the first receiving coil arrangement and the second receiving coil arrangement respectively generate a first and a second output signal dependent on the position of the target, and wherein the lateral width extent of the first and second planar receiving coil arrangements varies in each case along the movement path of the target.

### CROSS-REFERENCE TO RELATED APPLICATION

This application claims priority to Germany Patent Application No. 102023209159.3 filed on Sep. 20, 2023, the content of which is incorporated by reference herein in its entirety.

### TECHNICAL FIELD

The innovative concept described herein relates to inductively measuring linear displacement and rotation angle sensors.

### SUMMARY

In many applications in present-day life it is necessary to detect the absolute position of a linearly or rotationally moving object. While small movement ranges can be covered by magnetic sensor systems consisting e.g., of a linear Hall sensor and a simple dipole permanent magnet, larger movement ranges can only be realized by encoder tracks (multipole strip magnets), which results in a considerable increase in costs.

A typical application in the automotive sector that requires a large movement range is steering and rack position detection. Typical movement ranges here are up to 300 mm. Inductive sensors are particularly suitable for this.

Conventional position or angle detection systems based on inductive sensors are realized according to the nonius principle (two tracks with N and N+1 periods and two sensors). Each sensor yields a relative angle with N or N+1 periods. The absolute angle or the absolute position is ascertained by subtraction of the two angles.

The detectable linear range is high, but the system is complex since it requires at least one excitation coil and four receiving coils (sin/cos with N and N+1 periods) plus (typically) two sensors. In the layout, the four receiving coils cannot simply be distributed on two layers. Instead, they have to be arranged next to one another, which considerably enlarges the required printed circuit board area. Alternatively, a four-layered printed circuit board can be used instead of a two-layered printed circuit board. In this case, the two receiving coil conductor tracks are realized on separate layers, which results in a smaller installation space. Both variants (side-by-side or four-layered printed circuit board) increase the costs.

Alternatively, a solution with only one receiving coil signal period can also be used. However, this solution has a significantly lower accuracy on account of high signal deviations caused by slope effects of the receiving coils.

It would therefore be worthwhile to improve existing inductive position determination systems to the effect that they are producible in a space-saving and cost-effective manner and at the same time have a high resolution or accuracy.

This aim is achieved by an inductive position determination system and by a corresponding method for position determination using such an inductive position determination system according to the independent claims. Further implementations and advantageous aspects of the position determination system and of the corresponding method are specified in the respective dependent patent claims.

The inductive position determination system described herein includes, inter alia, a planar excitation coil and a first and a second planar receiving coil arrangement arranged within the planar excitation coil. The position determination system furthermore includes a target that is movable relative to the first and second planar receiving coil arrangements. The first receiving coil arrangement and the second receiving coil arrangement respectively generate a first and a second output signal dependent on the position of the target. In accordance with the innovative concept presented here, the lateral extent of the first and second planar receiving coil arrangements varies in each case along the movement path of the target.

The innovative method presented here for position determination using such an inductive position determination system provides, inter alia, for providing a first and a second planar receiving coil arrangement and a target that is movable relative to the first and second planar receiving coil arrangements. In this case, the innovative concept provides for the lateral extent of the first and second planar receiving coil arrangements to vary in each case along a movement path of the target. The method additionally includes detecting a first and a second output signal respectively generated by the first and second receiving coil arrangements depending on the position of the target. The method furthermore includes combining the first and second output signals in order to obtain a vector, wherein the rotation angle of the vector yields an ambiguous position indication of the target, and wherein the length of the vector describes the signal amplitude of the two combined output signals, the signal amplitude being dependent on the actual position of the target. Finally, an unambiguous position of the target is determined, based on the rotation angle and the length of the vector.

### BRIEF DESCRIPTION OF THE DRAWINGS

A few example implementations are illustrated by way of example in the drawing and explained below. In the figures:

FIG. 1 shows a schematic plan view of a conventional inductive linear displacement sensor for elucidating the general functional principle,

FIG. 2 shows a schematic plan view of an inductive single-track position determination system in accordance with one example implementation,

FIG. 3A shows a schematic diagram for illustrating the output signals which are generable using the position determination system from FIG. 2,

FIG. 3B shows a schematic diagram for illustrating the relative angle calculated from the two output signals from FIG. 3A, including the associated vector length,

FIG. 3C shows a schematic diagram for illustrating FIG. 3B in polar coordinates, and

FIG. 3D shows a schematic diagram for illustrating the angle error of the position determination system.

### DETAILED DESCRIPTION

Example implementations are described in more detail hereinbelow with reference to the figures, with elements that have the same or similar function being provided with the same reference signs.

Method steps depicted or described within the scope of the present disclosure may also be carried out in a sequence that differs from the depicted or described one. Moreover, method steps that relate to a particular feature of a device are able to be exchanged with this feature of the device, this also applying the other way round.

The inductive position determination system described herein is described below based on the example of a linear displacement sensor. However, the principles likewise apply to rotation angle sensors for determining a rotation angle.

Moreover, a description is given below of example implementations in which the position determination system comprises two receiving coil arrangements that are phase-offset (e.g., by 90°) with respect to one another. These examples are concerned with 2-phase systems. However, 3-phase systems would be conceivable, too, in which three receiving coil arrangements that are phase-offset (e.g., by 60° in each case) with respect to one another would accordingly be provided.

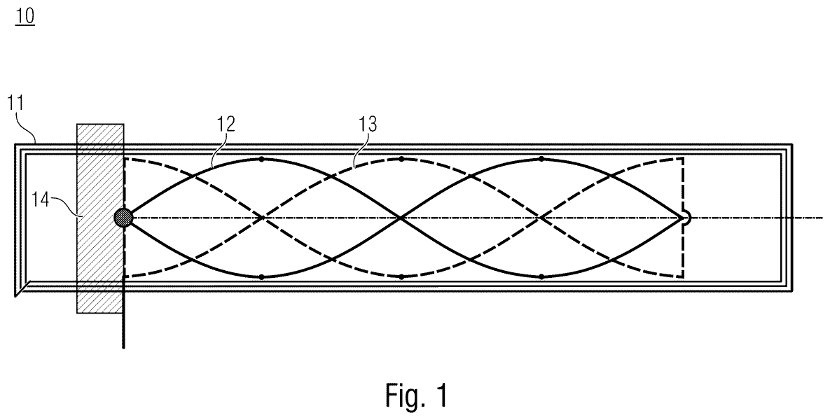

FIG. 1 firstly shows a conventional inductive position determination system 10, based on which the general functional principle of inductive position determination is intended to be explained in a general way beforehand prior to more specific discussion of the details of the present innovative concept.

The position determination system 10 shown in FIG. 1 comprises a planar excitation coil 11 and two planar receiving coil arrangements 12, 13. An inductive target 14 moves along the extension direction of the coils 11, 12, 13. The actual position of the target 14 is intended to be determined using the position determination system 10.

For this purpose, firstly an AC signal is applied to the excitation coil 11, whereby an induced current is induced in the target 14. The target 14 in turn generates an induced current in the receiving coil arrangements 12, 13, which then each generate a corresponding output signal. In this case, the first receiving coil arrangement 12 generates a first output signal, and the second receiving coil arrangement generates a second output signal. In this case, the amplitude of the respective output signal depends on the actual position of the target 14 relative to the two receiving coils 12, 13.

The two receiving coils 11, 12 here are configured in sinusoidal and respectively cosinusoidal fashion, thus resulting in a sinusoidal and respectively cosinusoidal signal profile of the corresponding output signals. The two output signals are combined with one another, e.g., using an arc-tangent calculation, in order to obtain an unambiguous value representing the actual position of the target 14.

This unambiguous value arises since the receiving coil arrangements 12, 13 have exactly one period, e.g., one full oscillation, over the entire travel of the target 14. Consequently, exactly one unambiguous combined signal value, e.g., an arc-tangent value, arises at each actual position of the target 14.

However, an account of just the single period, the position determination system 10 shown in FIG. 1 has a very coarse resolution, and thus a very low accuracy. Owing to edge effects, moreover, a very large signal offset occurs, resulting in additional deterioration of the signal quality.

However, many technical applications nowadays require a high to very high resolution or accuracy in the position determination. This is achieved, inter alia, by increasing the number of periods of the receiving coil arrangements 12, 13. As a result, the actual position ascertained can be resolved with higher resolution, e.g., in smaller steps.

As the number of periods increases, ambiguities inevitably occur, however, since the individual periods at the corresponding locations each yield the same signal values. That is to say that after each pass of a full period, the signal values are repeated with the pass of the succeeding period.

A number of approaches are conceivable for resolving these ambiguities. By way of example, the so-called nonius principle can be applied, which is also known from mechanical vernier calipers. However, this necessitates two further receiving coil arrangements with a different number of periods (and the previous two receiving coil arrangements) and also two sensors, which in turn increases the complexity of the set-up of the position determination system 10 and thus increases the production costs. In the case of a 3-phase system, a total of six receiving coil arrangements would even be necessary.

The innovative concept described herein provides a solution to the problems mentioned above. A position determination system is proposed which manages with just two (in the case of a 2-phase system) or three (in the case of a 3-phase system) receiving coil arrangements and a single sensor. It can be produced cost-efficiently as a result. At the same time an innovative possibility for resolving the ambiguities mentioned above is proposed, thereby achieving an increase in the resolution or accuracy in the position determination.

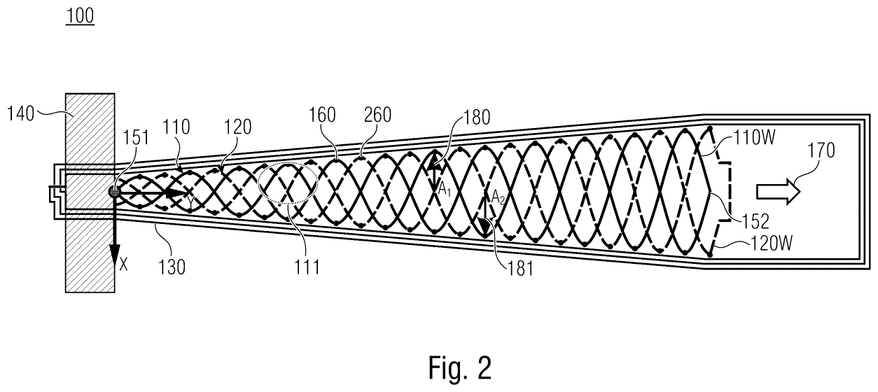

FIG. 2 shows one conceivable example implementation of an innovative position determination system 100. The position determination system 100 comprises a planar excitation coil 130. Moreover, the position determination system 100 comprises a first planar receiving coil arrangement 110 arranged within the planar excitation coil 130 and a second planar receiving coil arrangement 120 arranged within the planar excitation coil 130.

Planar means that the respective coils 110, 120, 130 are configured in flat fashion and are arranged within a plane. In FIG. 2, this is clarified schematically with the aid of a two-dimensional coordinate system having an x-axis and a y-axis. In this case, the coils 110, 120, 130 can be arranged in one and the same plane. However, the coils 110, 120, 130 can also be arranged in different planes arranged parallel to one another. By way of example, the respective coils 110, 120, 130 can be arranged in different layers of a multilayered (e.g., two-layered) substrate.

By way of example, the respective receiving coil arrangements 110, 120 can have through contacts 160, 260 at suitable locations, wherein the through contacts 160, 260 interconnect two substrate layers situated one above the other. The respective receiving coil arrangements 110, 120 can thus switch substrate layer at these through contacts 160, 260. That is to say that, for example, a receiving coil arrangement 110, 120 can firstly extend in a first substrate layer and switch to the second substrate layer using the through contact 160, 260. Consequently, the receiving coil arrangements 110, 120 can be arranged alternately in different substrate layers, such that the receiving coil arrangements 110, 120 can as it were be interwoven with one another in a multilayered substrate.

Each planar receiving coil arrangement 110, 120 comprises a planar winding 110W, 120W having a plurality of turns 111. A planar winding 110W can in this case extend from a starting point 151 to an end point 152 and in this case comprise a plurality of turns 111. The planar receiving coil arrangements 110, 120 can have a sinusoidal shape extending in the plane, for example, wherein a winding 110W, 120W describes the entire sinusoidal progression between the starting point 151 and the end point 152, and wherein a turn 111 corresponds in each case to a half-cycle. Two successive half-cycles or turns 111 would thus correspond to one period.

The two receiving coil arrangements 110, 120 can have the same periodicity, that is to say that both receiving coil arrangements 110, 120 have the same number of periods. In the non-limiting example implementation shown here, both receiving coil arrangements 110, 120 have a periodicity of “6”, e.g., both receiving coil arrangements 110, 120 have six full periods or twelve half-cycles or turns 111.

In the example implementation depicted in FIG. 2, the two receiving coil arrangements 110, 120 are each configured in the form of so-called astatic coils. This will be explained based on the example of the first receiving coil arrangement 110, although this likewise applies to the second receiving coil arrangement 120. In the case of an astatic receiving coil arrangement 110, its (e.g., sinusoidal) winding 110W can firstly extend from a starting point 151 in a first direction (here e.g., from left to right) along the longitudinal extension direction (e.g., in the y-direction) of the first receiving coil arrangement 110. At an end 152 of the astatic receiving coil arrangement 110, the winding 110W can then turn back and be guided back to the starting point 151 again (e.g., from right to left), wherein the individual turns 111 of the winding 110W extending with opposite winding senses are phase-offset by 180° with respect to one another. This results in the double sine curves per receiving coil arrangement 110, 120 that are discernible here. Homogeneous stray fields can be compensated for using an astatic receiving coil arrangement 110, 120.

The receiving coil arrangements 110, 120 have a longitudinal extension direction 170 and a lateral width extent 180 extending perpendicular thereto. In the example implementation depicted in FIG. 2, the aforementioned longitudinal extension direction 170 can extend along the depicted y-axis, for example, and the lateral width extent 180 can be established perpendicular thereto, e.g., along the depicted x-axis, for example. In other words, the lateral width extent 180 of the first and second planar receiving coil arrangements 110, 120 is established in each case perpendicular (e.g., in the x-direction) to the longitudinal extension direction 170 thereof (e.g., y-direction).

As mentioned above, the two receiving coil arrangements 110, 120 can each be configured in sinusoidal fashion and have a plurality of, e.g., two or more, successive periods. In other words, each planar receiving coil arrangement 110, 120 can have the geometric shape of a sinusoidal oscillation.

If the receiving coil arrangements 110, 120 are configured in sinusoidal fashion, the lateral width extent 180 can be equated with the amplitude Aₓ (see e.g., A₁, A₂) of the respective sinusoidal shape, and the period duration (e.g., two successive half-cycles 111) of the respective planar receiving coil arrangement 110, 120 is established in the longitudinal extension direction 170 thereof.

In the case of the 2-phase system depicted here by way of example, the two receiving coil arrangements 110, 120 can be offset by 90° in each case with respect to one another, such that the geometries of the two receiving coil arrangements 110, 120 correspond to a sinusoidal and a cosinusoidal oscillation. In the case of a 3-phase system, by contrast, a further sinusoidal receiving coil arrangement (not depicted here) could be provided, wherein all three receiving coil arrangements can then be offset by 60° in each case with respect to one another. The respective offset relates here to an offset along the longitudinal extension direction 170 or along the movement direction of the target 140. A third receiving coil arrangement may be provided with a similar structure to the receiving coil arrangements 110, 120, wherein all three receiving coil arrangements are offset by 60° in each case with respect to one another.

The position determination system 100 additionally comprises a target 140 that is movable relative to the first and second planar receiving coil arrangements 110, 120. The target 140 can be configured in the form of a metal lamina, for example. The movable target 140 can move linearly, e.g., along a linear path. As can be seen in FIG. 2, the target 140 can in this case move along the longitudinal extension direction 170 of the planar receiving coil arrangements 110, 120, for example. The target 140 can thus have for example a movement path which proceeds from a starting point 151 and extends in the longitudinal extension direction 170 of the two receiving coil arrangements 110, 120.

In the example shown in FIG. 2, the planar receiving coil arrangements 110, 120 extend substantially rectilinearly along their longitudinal extension direction 170. However, it would likewise be conceivable for the planar receiving coil arrangements 110, 120 to extend in curved fashion, e.g., in wavy fashion or in ring-shaped fashion. By way of example, the planar receiving coil arrangements 110, 120 could be arranged in circular fashion. In this case, the target 140 that is movable along the longitudinal extension direction 170 of the receiving coil arrangements 110, 120 could move on a corresponding circular path, such that a rotation angle sensor could be provided instead of the linear displacement sensor shown by way of example in FIG. 2.

In any case, the first receiving coil arrangement 110 and the second receiving coil arrangement 120 can respectively generate a first and a second output signal dependent on the actual position of the target 140. In other words, the first receiving coil arrangement 110 can generate a first output signal, and the second receiving coil arrangement 120 can generate a different second output signal.

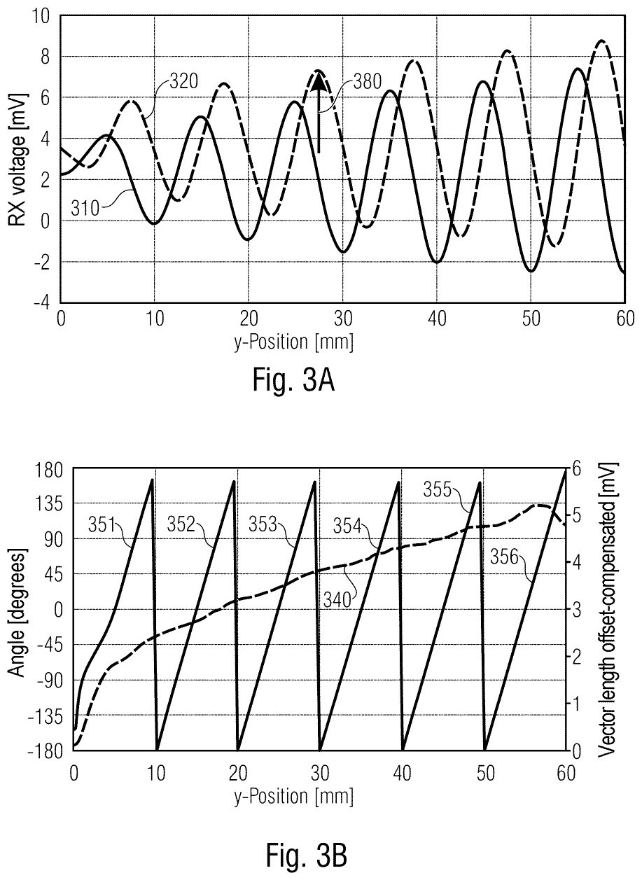

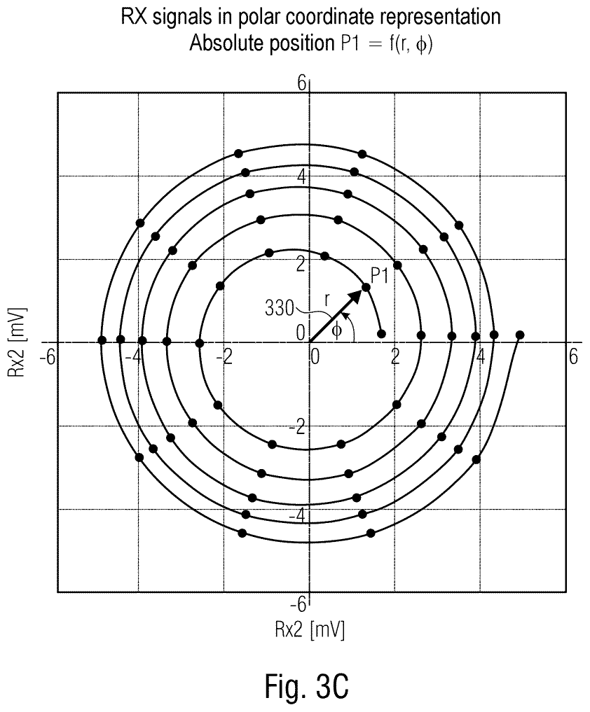

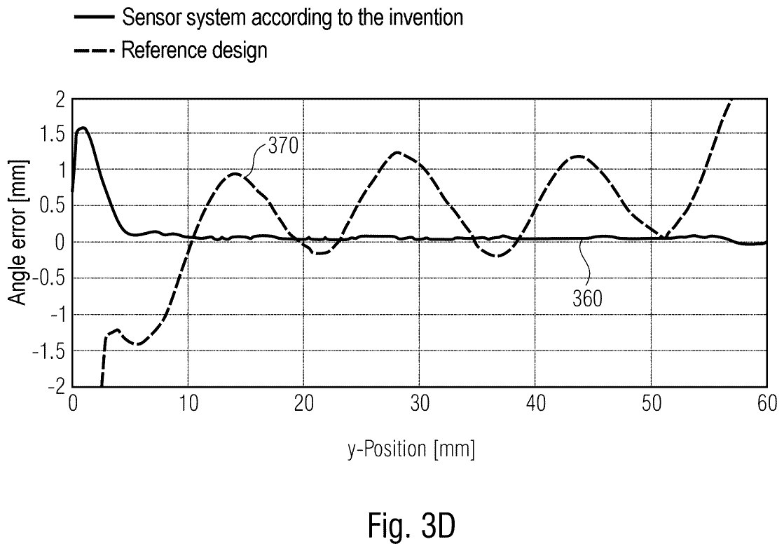

In this case, the signal waveform of the output signals can be oriented to the geometry of the respective receiving coil arrangement 110, 120. By way of example, a sinusoidal receiving coil arrangement 110, 120 can generate a sinusoidal signal profile. This is discussed in greater detail below with reference to FIG. 3A.

The innovative concept described herein provides at any rate for the lateral width extent 180 (e.g., in the x-direction) of the first and second planar receiving coil arrangements 110, 120 to vary in each case along the movement path of the target 140, or over the longitudinal extension direction 170 of the receiving coil arrangements 110, 120. To put it another way, the physical amplitude Aₓ of the respective receiving coil arrangement 110, 120 can vary over the longitudinal extension direction 170 thereof, which is illustrated purely by way of example with the aid of a first physical amplitude A₁ and a larger second physical amplitude A₂.

In the example implementation shown in FIG. 2, the lateral width extent 180 or the physical amplitude Aₓ of the respective receiving coil arrangement 110, 120 becomes larger and larger along the movement path of the target 140 (here: from left to right). By way of example, the lateral width extent 180 or the physical amplitude Aₓ of the respective receiving coil arrangement 110, 120 can increase continuously, e.g., linearly, along the movement path of the target 140 (here: from left to right). In this regard, for example, the lateral width extent 180 or physical amplitude A₁ depicted in FIG. 2 is smaller than the lateral width extent 181 or physical amplitude A₂. As a result, the planar receiving coil arrangements 110, 120 acquire a funnel shape, as is readily discernible in the plan view depicted in FIG. 2.

However, it would also be conceivable for the lateral width extent 180 or the physical amplitude Aₓ of the respective receiving coil arrangement 110, 120 to become smaller and smaller along the movement path of the target 140 (here: from left to right). By way of example, the lateral extent 180 or the physical amplitude Aₓ of the respective receiving coil arrangement 110, 120 can decrease continuously, e.g., linearly, along the movement path of the target 140 (here: from left to right).

However, the lateral extent 180 or the physical amplitude Aₓ of the respective receiving coil arrangement 110, 120 can also change non-continuously along the movement path of the target 140 (here: from left to right). It should be noted at any rate that no lateral width extents 180 or physical amplitudes Aₓ having identical magnitudes occur between the starting point 151 and the reversal or end point 152. The lateral width extents 180 or physical amplitudes Aₓ are thus all different or unique across the entire movement path of the target 140, that is to say that there is no amplitude value that occurs two or more times. As a result, it is possible to avoid ambiguities in the signal evaluation or position determination (see also the discussion below with reference to FIG. 3A).

As is shown by way of example in FIG. 2, the lateral width extent 180 or the physical amplitudes Aₓ of the first and second planar receiving coil arrangements 110, 120 can change in each case to equal proportions over the longitudinal extension direction 170 thereof. In other words, the lateral width extent 180 or physical amplitude Aₓ of the first receiving coil arrangement 110 changes in equal measure with the lateral extent 180 or physical amplitude Aₓ of the second receiving coil arrangement 120. That is to say that if one receiving coil arrangement becomes larger/smaller, the other receiving coil arrangement becomes larger/smaller proportionally thereto by the same proportion or factor.

By contrast, the period duration can remain unchanged. As can be seen in FIG. 2, the lateral width extent 180 or physical amplitude Aₓ of the respective receiving coil arrangement 110, 120 does change. By contrast, the respective period duration thereof, e.g., the length of a period to be established in the longitudinal extension direction 170, remains unchanged. This has the advantage that the output signals generated by the respective receiving coil arrangement 110, 120 likewise have a substantially constant period duration, thus resulting in a continuous signal profile, which in turn facilitates the signal evaluation.

As has already been mentioned in the introduction, the signal waveform of the output signals of the receiving coil arrangements 110, 120 can correlate with the geometric shaping thereof. By way of example, sinusoidal receiving coil arrangements 110, 120 can each generate a sinusoidal output signal.

FIG. 3A shows a diagram in which the output signals of the two receiving coil arrangements 110, 120 shown in FIG. 2 are plotted as a function of the actual position of the target 140. In this example, the output signals are the voltages induced in each of the receiving coil arrangements 110, 120. In order to compile the diagram shown in FIG. 3A, the excitation coil 130 was excited with an AC voltage of 2.4 V at a frequency of 3.5 MHz. The external dimensions of the excitation coil 130 were 15.7 mm×83 mm. The period length of the two receiving coil arrangements 110, 120 was 10 mm in each case. The lateral width extent 180 of the two receiving coil arrangements 110, 120 increased continuously from 2.5 mm to 12.5 mm between the starting point 151 and the end point 152. The air gap was 1 mm, and the dimensions of the target 140 were (length×width×thickness) 20 mm×5 mm×0.5 mm. The numerical values indicated are purely by way of example here and should therefore be interpreted as non-limiting.

The graph 310 shows the profile of the output signal of the first receiving coil arrangement 110. The graph 320 shows the profile of the output signal of the second receiving coil arrangement 120. Both signal profiles are likewise sinusoidal and have an offset in the x-direction. The vertical offset in the y-direction as shown here can be disregarded for the following consideration. The vertical offset can moreover be compensated for, if necessary, using conventional methods, for example by reducing the air gap (air gap between the target 140 and the receiving coil arrangements 110, 120).

As is readily discernible in FIG. 3A, the signal amplitude 380 of the respective output signal 310, 320 increases continuously along the movement path of the target 140, e.g., as the y-value increases. Accordingly, as the lateral width extent 180 increases (FIG. 2), the receiving coil arrangements 110, 120 thus generate an output signal with a correspondingly increasing signal amplitude 380. This incidentally is equally applicable in the other direction, that is to say that as the lateral width extent 180 decreases (FIG. 2), the signal amplitude 380 of the output signal of the respective receiving coil arrangement 110, 120 also decreases.

FIG. 3B shows a further diagram, in which the two output signals 310, 320 were combined with one another, here for example by applying the arc-tangent function. Here, too, the numerical values indicated are again purely by way of example and should therefore be interpreted as non-limiting. The position determination system 100 may include a processing circuit configured to combine the two output signals 310, 320. For example, the processing circuit may include a sampling circuit (e.g., analog or digital), a signal processor, and/or a computational processor.

As is evident, applying the arc-tangent function for each full period results in an angle of between −180° and +180°, which encodes the actual position (y-axis) of the target. However, the diagram reveals six successive passes 351, . . . , 356 with angles of in each case from −180° to +180°, thus resulting in ambiguities in the determination of the actual position of the target 140. This is owing to the fact that in the example shown in FIG. 2, the two receiving coil arrangements 110, 120 each have six periods, for which reason the output signals 310, 320 (FIG. 3A) likewise have six periods, and applying the arc-tangent function accordingly results in six identical passes 351, . . . , 356 of in each case from −180° to +180°. Consequently, the rotation angle on its own thus firstly yields an ambiguous position indication of the target 140.

In order to resolve these ambiguities, the innovative concept provides for concomitantly using the signal amplitudes 380 (FIG. 3A) for determining the position of the target 140. This will become somewhat clearer upon consideration of FIG. 3C. Here the combined output signals of the receiving coil arrangements 110, 120 are indicated in polar coordinates. The vector 330 here corresponds to the angle signal from FIG. 3B that is obtainable (e.g., by the processing circuit) using the arc-tangent function. Thus, the processing circuit may to combine the first output signal (310) and the second output signal (320) with one another in order to obtain the vector 330. The rotation angle Φ of the vector 330 in this case describes (is a measure of, indicates, or represents) the angle (y-axis) of between −180° and +180° per period or pass 351, . . . , 356 as shown in FIG. 3B, and the length r of the vector 330 describes the magnitude of the signal amplitude 380.

In FIG. 3C it is readily discernible here that as the rotation angle Φ of the vector 330 increases, the amplitude, e.g., the length r of the vector 330, also increases. The continuously increasing vector length r is attributable to the continuously increasing lateral width extent 180 of the two receiving coil arrangements 110, 120 (FIG. 2). As mentioned in the introduction, the signal amplitude 380 of the first and second output signals 310, 320 changes in each case proportionally to the changing lateral width extent 180 of the first and second planar receiving coil arrangements 110, 120. Consequently, as the lateral width extent 180 becomes larger/smaller, the signal amplitude 380 in each case also becomes proportionally larger/smaller.

FIG. 3C reveals very well that using the length r of the vector 330 in combination with the rotation angle Φ, each point in the polar coordinate system can be assigned exactly one unambiguous actual position of the target, such as e.g., P1=f(r, Φ).

Upon renewed consideration of FIG. 3B, then, the latter also reveals the vector length 340, which increases continuously across the entire movement path of the target 140 and always has an unambiguous value in this case. If a specific rotation angle Φ is then combined with the value of the vector length 340 prevailing at this point for each pass 351, . . . , 356, exactly one unambiguous combination of rotation angle Φ and signal amplitude 380 always results for each actual position across the entire movement path of the target 140. As a result, the abovementioned ambiguities can be resolved and the current actual position of the target 140 can be determined (e.g., by the processing circuit) with high resolution and unambiguously. Thus, the processing circuit may determine an unambiguous position of the target 140 based on the rotation angle Φ and the vector length 340 of the vector 330.

FIG. 3D clarifies this with the aid of the angle error in mm. Here, too, the numerical values indicated are again purely by way of example and should therefore be interpreted as non-limiting. As is evident, the innovative position determination system 100 has an angle error that is almost zero. This is illustrated with the aid of the graph 360. The initial excursion at the beginning of the actual position of the target is merely attributable to edge effects and can be compensated for. In comparison with the graph 360 having almost no angle error, the second graph 370 depicts the angle error of a reference system comprising receiving coil arrangements which have only a single period (FIG. 1). It is evident here that significant deviations (angle error) occur in the determination of the actual position of the target, which is attributable to the low resolution (only a single period).

One advantage of the innovative concept described herein resides, inter alia, in the fact that despite the provision of just two receiving coil arrangements 110, 120, a very high accuracy can be attained in the position determination for the target 140. Example implementations envisage that in a 2-phase system, exactly two receiving coil arrangements 110, 120 with identical periodicity are sufficient, wherein these two receiving coil arrangements 110, 120 are offset by 90° with respect to one another in the longitudinal extension direction. Further example implementations envisage that in a 3-phase system, exactly three receiving coil arrangements with identical periodicity are sufficient, wherein these three receiving coil arrangements are offset by 60° with respect to one another in the longitudinal extension direction. Moreover, exactly one target 140 is sufficient both in a 2-phase system and in a 3-phase system. Two or more receiving coil arrangements with identical periodicity are also referred to as single-track.

Significantly more components are necessary in conventional inductive position determination systems which apply a nonius principle in order to enable a comparable resolution or accuracy in the position determination. In the case of a 2-phase system, besides the two receiving coil arrangements with identical periodicity two further receiving coil arrangements with identical periodicity are required, wherein the periodicity of the first coil pair must differ from the periodicity of the second coil pair. Moreover, two different targets are required. Receiving coil arrangements with differing periodicity are also referred to as dual-track or multi-track. In the case of a 3-phase system according to the nonius principle, a total of six receiving coil arrangements and two targets are even necessary. In order to integrate the individual coils in a multilayered substrate, a respective metal layer per receiving coil arrangement is necessary in the substrate. Consequently, a substrate having at least four metal layers is required for a dual-track system. Moreover, a multi-RX input chip is required for realizing a multi-track position determination system.

By contrast, for the innovative single-track position determination system 100 presented herein, just exactly two or exactly three receiving coil arrangements with identical periodicity in each case are sufficient. The receiving coil arrangements here can be arranged in exactly two planes or layers. In this regard, for example, both in the case of a 2-phase system and in the case of a 3-phase system, a two-layered substrate, e.g., a substrate with exactly two integrated metal layers, is sufficient. Both in the case of a 2-phase system and in the case of a 3-phase system, as described initially with reference to FIG. 2, the individual receiving coil arrangements can be distributed or interwoven in one another across the individual layers.

The accuracy in the position determination can be increased even further with the present position determination system 100. As has already been mentioned above, the air gap, e.g., the vertical distance between the target 140 and the receiving coil arrangements 110, 120, can be altered in order to correct an offset, for example. For this purpose, a third planar receiving coil arrangement can be provided, for example, which is configured to generate a third output signal, wherein the third output signal describes the air gap, e.g., the distance between the target 140 and the third receiving coil arrangement. Consequently, the distance or air gap can be ascertained, and a measurement error induced by distance fluctuations in the position determination can thereby be compensated for.

In summary, the innovative concept described herein proposes an inductive single-track sensor system 100 for absolute position detection. Advantageously, in the case of 2-phase systems, just a single excitation coil 130 and exactly two receiving coil arrangements 110, 120 (e.g., sin/cos), and also a single sensor and a single target 140 are required here.

The planar coils 110, 120, 130 can be arranged on a substrate, such as e.g., a PCB (printed circuit board). The corresponding PCB layout comprises the two receiving coil arrangements 110, 120, which change their physical amplitude Aₓ or lateral width extent 180 depending on the movement position or movement direction of the target 140. The voltage amplitudes 380 induced in the receiving coil arrangements 110, 120 depend on the actual position of the target 140. From the falling/rising sinusoidal signal, the vector length 340 is calculated and, in combination with the arc-tangent function, the absolute angle or the position can be measured.

By evaluating the vector length 340 in combination with the arc-tangent, it is possible to determine an unambiguous actual position of the target 140. FIG. 3A shows an example simulation result for the position determination system 100 illustrated in FIG. 2.

The position determination system 100 can be realized on a two-layered printed circuit board, which results in reduced costs. The accuracy as well is significantly increased in comparison with conventional designs.

The innovative concept described herein is suitable for many industrial and automotive applications. It is conceivable for any application which requires an absolute position or angle detection, particularly in the case of large detectable movement ranges. The absolute linear position detection for a rack in the steering gear mechanism would be one typical application in the automotive sector.

The inductive position determination system 100 described herein has the following advantages, inter alia: a stray field immunity owing to inductive scanning principle, an increased accuracy (in comparison with standard layouts that suffer from edge effects), a smaller installation space/smaller area/requires only 2-layered PCB, requires only a single sensor, lower system costs since the absolute position/angle detection is realized by a set of exactly one excitation coil 130 and exactly two receiving coil arrangements 110, 120 on a 2-layered printed circuit board (e.g., the nonius principle requires at least a 4-layered printed circuit board or a larger printed circuit board area), the concept is applicable to linear displacement and rotation angle encoders, and the position determination system 100 can also be used for indexing.

The above-described example implementations are merely an illustration of the principles of the innovative concept described herein. It is to be understood that modifications and variations of the arrangements and details described in this document will be obvious to others skilled in the art. For this reason, the concept described herein is intended to be limited merely by the scope of protection of the following patent claims rather than by the specific details which have been presented based on the description and the explanation of the example implementations in this document.

Although some aspects have been described in connection with an apparatus, it is to be understood that the aspects also constitute a description of the corresponding method, with the result that a block or a structural element of an apparatus should also be understood to be a corresponding method step or a feature of a method step. Analogously herewith, aspects which were described in connection with a or as a method step also represent a description of a corresponding block or detail or feature of a corresponding apparatus.

### Aspects

The following provides an overview of some Aspects of the present disclosure:

Aspect 1: An inductive position determination system, comprising: a planar excitation coil; a first planar receiving coil arrangement arranged within the planar excitation coil; a second planar receiving coil arrangement arranged within the planar excitation coil; and a target that is movable, along a movement path, relative to the first planar receiving coil arrangement and the second planar receiving coil arrangement, wherein the first receiving coil arrangement and the second receiving coil arrangement are configured to respectively generate a first output signal dependent on a position of the target and a second output signal dependent on the position of the target, and wherein a lateral width extent of the first planar receiving coil arrangement and a lateral width extent of the second planar receiving coil arrangement each vary along the movement path of the target.

Aspect 2: The inductive position determination system according to Aspect 1, wherein the target is configured to move along a longitudinal extension direction of the first planar receiving coil arrangement and the second planar receiving coil arrangement.

Aspect 3: The inductive position determination system according to Aspect 2, wherein the lateral width extent of the first planar receiving coil arrangement and the lateral width extent of the second planar receiving coil arrangement are established perpendicular to the longitudinal extension direction of the first planar receiving coil arrangement and the second planar receiving coil arrangement.

Aspect 4: The inductive position determination system according to Aspect 2, wherein the lateral width extent of the first planar receiving coil arrangement and the lateral width extent of the second planar receiving coil arrangement change, in each case, in equal proportions over the longitudinal extension direction.

Aspect 5: The inductive position determination system according to any of Aspects 1-4, wherein the lateral width extent of the first planar receiving coil arrangement and the lateral width extent of the second planar receiving coil arrangement, in each case, becomes continuously larger along the movement path of the target.

Aspect 6: The inductive position determination system according to any of Aspects 1-5, wherein the lateral width extent of the first planar receiving coil arrangement and the lateral width extent of the second planar receiving coil arrangement, in each case, becomes continuously smaller along the movement path of the target.

Aspect 7: The inductive position determination system according to any of Aspects 1-6, wherein the first planar receiving coil arrangement is configured in sinusoidal fashion, wherein the lateral width extent of the first planar receiving coil arrangement corresponds to an amplitude dimension of a sinusoidal shape of the first planar receiving coil arrangement, and wherein a period duration of the sinusoidal shape is established in the longitudinal extension direction of the first planar receiving coil arrangement.

Aspect 8: The inductive position determination system according to Aspect 7, wherein the second planar receiving coil arrangement is configured in sinusoidal fashion and arranged offset with respect to the first planar receiving coil arrangement, wherein the lateral width extent of the second planar receiving coil arrangement corresponds to an amplitude dimension of a sinusoidal shape of the second planar receiving coil arrangement, and wherein the period duration of the sinusoidal shape is established in the longitudinal extension direction of the second planar receiving coil arrangement.

Aspect 9: The inductive position determination system according to Aspect 7, wherein the first planar receiving coil arrangement has a first multiplicity of sinusoidal periods with constant period duration and different amplitudes, and/or wherein the sinusoidal second planar receiving coil arrangement has a second multiplicity of sinusoidal periods with constant period duration and different amplitudes.

Aspect 10: The inductive position determination system according to any of Aspects 1-9, wherein a signal strength of the first output signal of the first planar receiving coil arrangement changes proportionally to the lateral width extent of the first planar receiving coil arrangement, wherein a signal strength of the second output signal of the second planar receiving coil arrangement changes proportionally to the lateral width extent of the second planar receiving coil arrangement, wherein as the lateral width extent of the first planar receiving coil arrangement changes, the signal strength of the first output signal changes proportionally, and wherein as the lateral width extent of the second planar receiving coil arrangement changes, the signal strength of the second output signal changes proportionally.

Aspect 11: The inductive position determination system according to any of Aspects 1-10, wherein the inductive position determination system is configured to combine the first output signal and the second output signal with one another in order to obtain a vector, wherein a rotation angle of the vector yields an ambiguous position indication of the target, wherein a length of the vector describes a signal amplitude of a combination of the first output signal and the second output signal, the signal amplitude being dependent on an actual position of the target, and wherein the inductive position determination system is configured to ascertain an unambiguous position of the target based on the rotation angle and the length of the vector.

Aspect 12: The inductive position determination system according to any of Aspects 1-11, wherein the inductive position determination system comprises exactly two planar receiving coil arrangements and/or exactly one target.

Aspect 13: The inductive position determination system according to any of Aspects 1-12, further comprising: a third planar receiving coil arrangement configured to generate a third output signal, wherein the third output signal describes a distance between the target and the third receiving coil arrangement, and wherein the inductive position determination system is configured, based on the third output signal, to compensate for a measurement error induced by distance fluctuations in a position determination.

Aspect 14: The inductive position determination system according to any of Aspects 1-13, further comprising: a two-layered substrate, wherein the first and second planar receiving coil arrangements are distributed in each case over the two layers of the two-layered substrate.

Aspect 15: The inductive position determination system according to any of Aspects 1-14, wherein the inductive position determination system is a linear displacement sensor, and wherein the first planar receiving coil arrangement and the lateral width extent of the second planar receiving coil arrangement each extend in rectilinear fashion, or wherein the inductive position determination system is a rotation angle sensor, and wherein the first planar receiving coil arrangement and the lateral width extent of the second planar receiving coil arrangement each extend in ring-shaped fashion.

Aspect 16: The inductive position determination system according to any of Aspects 1-15, further comprising: a third planar receiving coil arrangement arranged within the planar excitation coil, wherein the first receiving coil arrangement, the second receiving coil arrangement, and the third receiving coil arrangement respectively generate the first output signal, the second output signal, and a third output signal dependent on the position of the target, and wherein a lateral width extent of the third planar receiving coil arrangement varies along the movement path of the target.

Aspect 17: The inductive position determination system according to any of Aspects 1-16, wherein the first planar receiving coil arrangement has a first multiplicity of sinusoidal periods with constant period duration along a longitudinal extension direction and different amplitudes that define the lateral width extent of the first planar receiving coil, and wherein the sinusoidal second planar receiving coil arrangement has a second multiplicity of sinusoidal periods with constant period duration along the longitudinal extension direction and different amplitudes that define the lateral width extent of the second planar receiving coil.

Aspect 18: The inductive position determination system according to any of Aspects 1-17, wherein the first output signal is dependent on a position of the target relative to the first planar receiving coil arrangement, and wherein the second output signal is dependent on a position of the target relative to the second planar receiving coil arrangement.

Aspect 19: A method for position determination using an inductive position determination system, wherein the method comprises: providing a first planar receiving coil arrangement, a second planar receiving coil arrangement, and a target that is movable relative to the first planar receiving coil arrangement and the second planar receiving coil arrangement; wherein a lateral width extent of the first planar receiving coil arrangement and a lateral width extent of the second planar receiving coil arrangement each vary along a movement path of the target; detecting a first output signal and a second output signal respectively generated by the first planar receiving coil arrangement and the second planar receiving coil arrangement depending on a position of the target; combining the first output signal and a second output signal in order to obtain a vector, wherein a rotation angle of the vector yields an ambiguous position indication of the target, and wherein a length of the vector describes a signal amplitude of a combination of the first output signal and the second output signal, the signal amplitude being dependent on an actual position of the target; and ascertaining an unambiguous position of the target based on the rotation angle and the length of the vector.

Aspect 20: A system configured to perform one or more operations recited in one or more of Aspects 1-19.

Aspect 21: An apparatus comprising means for performing one or more operations recited in one or more of Aspects 1-19.

Aspect 22: A non-transitory computer-readable medium storing a set of instructions, the set of instructions comprising one or more instructions that, when executed by a device, cause the device to perform one or more operations recited in one or more of Aspects 1-19.

Aspect 23: A computer program product comprising instructions or code for executing one or more operations recited in one or more of Aspects 1-19.

1. An inductive position determination system, comprising:
a planar excitation coil;
a first planar receiving coil arrangement arranged within the planar excitation coil;
a second planar receiving coil arrangement arranged within the planar excitation coil; and
a target that is movable, along a movement path, relative to the first planar receiving coil arrangement and the second planar receiving coil arrangement,
wherein the first receiving coil arrangement and the second receiving coil arrangement are configured to respectively generate a first output signal dependent on a position of the target and a second output signal dependent on the position of the target, and
wherein a lateral width extent of the first planar receiving coil arrangement and a lateral width extent of the second planar receiving coil arrangement each vary along the movement path of the target.

2. The inductive position determination system according to claim 1,
wherein the target is configured to move along a longitudinal extension direction of the first planar receiving coil arrangement and the second planar receiving coil arrangement.

3. The inductive position determination system according to claim 2,
wherein the lateral width extent of the first planar receiving coil arrangement and the lateral width extent of the second planar receiving coil arrangement are established perpendicular to the longitudinal extension direction of the first planar receiving coil arrangement and the second planar receiving coil arrangement.

4. The inductive position determination system according to claim 2,
wherein the lateral width extent of the first planar receiving coil arrangement and the lateral width extent of the second planar receiving coil arrangement change, in each case, in equal proportions over the longitudinal extension direction.

5. The inductive position determination system according to claim 1,
wherein the lateral width extent of the first planar receiving coil arrangement and the lateral width extent of the second planar receiving coil arrangement, in each case, becomes continuously larger along the movement path of the target.

6. The inductive position determination system according to claim 1,
wherein the lateral width extent of the first planar receiving coil arrangement and the lateral width extent of the second planar receiving coil arrangement, in each case, becomes continuously smaller along the movement path of the target.

7. The inductive position determination system according to claim 1,
wherein the first planar receiving coil arrangement is configured in sinusoidal fashion,
wherein the lateral width extent of the first planar receiving coil arrangement corresponds to an amplitude dimension of a sinusoidal shape of the first planar receiving coil arrangement, and
wherein a period duration of the sinusoidal shape is established in the longitudinal extension direction of the first planar receiving coil arrangement.

8. The inductive position determination system according to claim 7,
wherein the second planar receiving coil arrangement is configured in sinusoidal fashion and arranged offset with respect to the first planar receiving coil arrangement,
wherein the lateral width extent of the second planar receiving coil arrangement corresponds to an amplitude dimension of a sinusoidal shape of the second planar receiving coil arrangement, and
wherein the period duration of the sinusoidal shape is established in the longitudinal extension direction of the second planar receiving coil arrangement.

9. The inductive position determination system according to claim 7,
wherein the first planar receiving coil arrangement has a first multiplicity of sinusoidal periods with constant period duration and different amplitudes, and/or
wherein the sinusoidal second planar receiving coil arrangement has a second multiplicity of sinusoidal periods with constant period duration and different amplitudes.

10. The inductive position determination system according to claim 1,
wherein a signal strength of the first output signal of the first planar receiving coil arrangement changes proportionally to the lateral width extent of the first planar receiving coil arrangement,
wherein a signal strength of the second output signal of the second planar receiving coil arrangement changes proportionally to the lateral width extent of the second planar receiving coil arrangement,
wherein as the lateral width extent of the first planar receiving coil arrangement changes, the signal strength of the first output signal changes proportionally, and
wherein as the lateral width extent of the second planar receiving coil arrangement changes, the signal strength of the second output signal changes proportionally.

11. The inductive position determination system according to claim 1,
wherein the inductive position determination system is configured to combine the first output signal and the second output signal with one another in order to obtain a vector,
wherein a rotation angle of the vector yields an ambiguous position indication of the target,
wherein a length of the vector describes a signal amplitude of a combination of the first output signal and the second output signal, the signal amplitude being dependent on an actual position of the target, and
wherein the inductive position determination system is configured to ascertain an unambiguous position of the target based on the rotation angle and the length of the vector.

12. The inductive position determination system according to claim 1,
wherein the inductive position determination system comprises exactly two planar receiving coil arrangements and/or exactly one target.

13. The inductive position determination system according to claim 1, further comprising:
a third planar receiving coil arrangement configured to generate a third output signal,
wherein the third output signal describes a distance between the target and the third receiving coil arrangement, and
wherein the inductive position determination system is configured, based on the third output signal, to compensate for a measurement error induced by distance fluctuations in a position determination.

14. The inductive position determination system according to claim 1, further comprising:
a two-layered substrate, wherein the first and second planar receiving coil arrangements are distributed in each case over the two layers of the two-layered substrate.

15. The inductive position determination system according to claim 1,
wherein the inductive position determination system is a linear displacement sensor, and wherein the first planar receiving coil arrangement and the lateral width extent of the second planar receiving coil arrangement each extend in rectilinear fashion, or
wherein the inductive position determination system is a rotation angle sensor, and wherein the first planar receiving coil arrangement and the lateral width extent of the second planar receiving coil arrangement each extend in ring-shaped fashion.

16. The inductive position determination system according to claim 1, further comprising:
a third planar receiving coil arrangement arranged within the planar excitation coil,
wherein the first receiving coil arrangement, the second receiving coil arrangement, and the third receiving coil arrangement respectively generate the first output signal, the second output signal, and a third output signal dependent on the position of the target, and
wherein a lateral width extent of the third planar receiving coil arrangement varies along the movement path of the target.

17. A method for position determination using an inductive position determination system, wherein the method comprises:
providing a first planar receiving coil arrangement, a second planar receiving coil arrangement, and a target that is movable relative to the first planar receiving coil arrangement and the second planar receiving coil arrangement;
wherein a lateral width extent of the first planar receiving coil arrangement and a lateral width extent of the second planar receiving coil arrangement each vary along a movement path of the target;
detecting a first output signal and a second output signal respectively generated by the first planar receiving coil arrangement and the second planar receiving coil arrangement depending on a position of the target;
combining the first output signal and a second output signal in order to obtain a vector, wherein a rotation angle of the vector yields an ambiguous position indication of the target, and wherein a length of the vector describes a signal amplitude of a combination of the first output signal and the second output signal, the signal amplitude being dependent on an actual position of the target; and
ascertaining an unambiguous position of the target based on the rotation angle and the length of the vector.

18. The inductive position determination system according to claim 1,
wherein the first planar receiving coil arrangement has a first multiplicity of sinusoidal periods with constant period duration along a longitudinal extension direction and different amplitudes that define the lateral width extent of the first planar receiving coil, and
wherein the sinusoidal second planar receiving coil arrangement has a second multiplicity of sinusoidal periods with constant period duration along the longitudinal extension direction and different amplitudes that define the lateral width extent of the second planar receiving coil.

19. The inductive position determination system according to claim 1,
wherein the first output signal is dependent on a position of the target relative to the first planar receiving coil arrangement, and
wherein the second output signal is dependent on a position of the target relative to the second planar receiving coil arrangement.
